(19) United States
(12) Patent Application Publication
(10) Pub. No.: US 2009/0209717 A1
(43) Pub. Date: Aug. 20, 2009

(54) Shape Memory Polymer with Polyester and Polyether Segments and Process for Its Preparation and Programming

(75) Inventors: Steffen Kelch, Oberengstringen (CH); Andreas Lendlein, Berlin (DE); Ingo Bellin, Mannheim (DE)

Correspondence Address: Nixon Peabody LLP, 200 Page Mill Road, Suite 200, Palo Alto, CA, 94306, US

(73) Assignee: GKSS-FORSCHUNGSZENTRUM GEESTHACHT GMBH, Geesthacht (DE)

(21) Appl. No.: 12/282,513

(22) PCT Filed: Mar. 13, 2007
(86) PCT No.: PCT/EP2007/052345

§ 371 Date: Sep. 29, 2008

(30) Foreign Application Priority Data
Mar. 14, 2006 (DE) 10 2006 012 169.4

(51) Int. Cl. C08G 63/00; C08F 118/02

(52) U.S. Cl. 526/319; 528/271; 528/354

(57) ABSTRACT

The invention relates to a shape memory polymer, to a process for its preparation, to a process for its programming and to its use. The inventive shape memory polymer has at least two switch segments with different transition temperatures (Ttrans,1, Ttrans,2), such that the polymer, depending on the temperature, as well as a permanent shape (PF), can assume at least two temporary shapes (TF1, TF2). The first switch segment is based essentially on a polyester of the general Formula (I) where n=1 . . . 6 or a copolyester of the general Formula (I) with different n or a derivative thereof. The second switch segment is based essentially on a polyether of the general Formula (II) where m=1 . . . 4 or a copolyether of the general Formula II with different m or a derivative thereof.

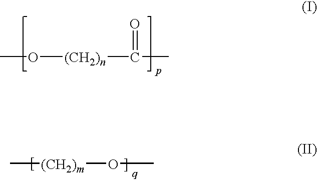

The invention relates to a shape memory polymer that, in addition to a permanent shape, can memorize at least two temporary shapes, a process for its preparation and a process for programming its shape, as well as its use.

So-called shape memory polymers or SMPs that, upon induction by an appropriate stimulus, display a shape transition from a temporary shape to a permanent shape consistent with previous programming, have been known from prior art. Most frequently, this shape memory effect is thermally stimulated, i.e., when the polymer material is heated to above the defined transition temperature, resetting triggered by entropic elasticity occurs. As a rule, shape memory polymers are polymer networks where chemical (covalent) or physical (non-covalent) cross-linking sites define the permanent shape. Programming is achieved in that the polymer material is deformed above the transition temperature of a switch segment and subsequently cooled to below this temperature while the deformation forces are maintained in order to fix the temporary shape. Renewed heating above the transition temperature results in a phase transition and the restoration of the original permanent shape.

Furthermore, in recent times, polymer networks have been described, said networks having two switch segments with different transition temperatures.

For example, document EP 1 362 879 A describes shape memory polymers (in this case interpenetrating networks—IPNs) that consist of a covalently cross-linked polymer component, in particular on the basis of caprolactone units, lactid units, glycolid units or p-dioxano units, and of a non-covalently cross-linked polyester urethane component. The polymer is capable of storing two temporary shapes, whereby the transition temperatures are said to be about 50 and 90° C.

Also, Liu et al (Macromol. Rap. Comm. 26, 2005, 649 ff) discloses an SMP (semi-interpenetrating network—SIPN) consisting of polymethyl methacrylate units (PMMA) and polyethylene glycol units (PEG) that also has two transition temperatures (40 and 86° C.). The programming process described there, however, permits only the memory of one temporary shape.

An important field of use of shape memory polymers is medical technology where such materials can be used, for example, as self-knotting suture material or as implant material. In many such applications resorbable polymers that are hydrolytically degraded in the body after some time are desirable. The disadvantage of the known shape memory polymers is that their switch temperatures are outside a physiologically tolerable range and/or that they are not resorbable or that they, or their decomposition products, are not biocompatible.

The object of the invention is to provide a new biocompatible shape memory polymer that is capable of memorizing at least two temporary shapes. The corresponding switch temperatures of the polymer should be within a physiologically acceptable range, i.e., the stimulation of the shape memory should be possible without damaging the surrounding cells. Furthermore, a method for programming at least two temporary shapes of the shape memory polymer is to be provided.

This object is achieved by a shape memory polymer displaying the features of claim 1. The shape memory polymer in accordance with the invention comprises at least two switch segments with different transition temperatures so that the polymer material may—as a function of temperature—take at least two temporary shapes in addition to one permanent shape. The polymer system in accordance with the invention comprises a first switch segment that is essentially based on a polymer having the general Formula I where n=1 . . . 6, or on a derivative thereof, or on a copolyester having the general Formula I where n=1 . . . 6, wherein at least two ester units having different chain lengths n are present, or on a derivative thereof.

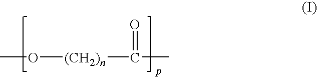

Furthermore, the polymer system comprises a second switch segment that is essentially based on a polyether having the general Formula II where m=1 . . . 4, or on a copolyether having the general Formula II where m=1 . . . 4, wherein at least two ether units having different chain lengths m are present, or on a derivative thereof.

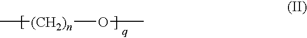

In conjunction with this, the term switch segment is understood to mean an oligomer or polymer in accordance with the given Formula I or II, said oligomer or polymer having a chain length p or q, that permits the formation of a separate phase due to phase segregation in the solid and thus provides the basis for the formation of typical material properties of the corresponding compound. In this manner, it is achieved that the polymer system as a whole displays material properties that can be associated with the respective switch segments, in particular, two or more different switch temperatures for the thermally induced effect, said temperatures potentially representing—independent of each other—glass transition temperatures or melting temperatures. From the viewpoint of the structure, the switch segments may be covalently or non-covalently cross-linked and terminal, linked to each other on one side or on both sides, and/or linked to a polymer spine. Furthermore, within the limitations of the present invention, derivatives of the polyester in accordance with Formula I and/or derivatives of the polyether in accordance with Formula II comprise structures, wherein one or more hydrogen radicals of the methylene units (—CH₂—) are substituted by unbranched or branched, saturated or unsaturated C1 through C6 radicals. Considering the present limitations, the selection of the substituents should be such that the formation of a separate phase of the switch segments is not prevented.

As a result of the inventive composition, a material is made available that, following appropriate programming, is able to fix at least two deformations at the same time, whereby said deformations can be restored after being activated by appropriate thermal stimuli. A particularly advantageous property of the inventive polymer system has been found to be switch temperatures that are within a physiologically acceptable range. In particular, the two switch temperatures of the switch segments in accordance with Formulae I and II are below 85° C. Preferably, the monomer units, their substituents, as well as the chain lengths of the switch segments, are selected such that the switch temperatures are below 80° C., preferably below 75° C. A further advantage consists in that both switch segment polymers are physiologically resorbable and that their decomposition products are physiologically compatible.

Referring to a preferred embodiment of the invention, the first switch segment comprises a poly(ε-caprolactone) segment where n=5, or a derivative thereof, wherein the aliphatic carbon atoms, independently of each other, may be substituted by one or two, unbranched or branched, saturated or unsaturated C1 through C6 radicals. Particularly preferred, however, is the non-derivatized poly(ε-caprolactone) where n=5 in accordance with Formula I, i.e., without substituents.

Referring to another advantageous embodiment of the invention, the second switch segment comprises a polyethylene glycol segment where m=2, or a derivative thereof, wherein the aliphatic carbon atoms, independently of each other, may be substituted with one or two, unbranched or branched, saturated or unsaturated C1 through C6 radicals. However, particularly preferred is again the non-derivatized polyethylene glycol where m=2 in accordance with Formula II.

The molecular weights of the segments as well as their mass fractions in the polymer and their relative mass ratios (first switch segment:second switch segment) are adjusted in such a manner that the above-described switch temperatures are not exceeded and that distinct shape changes are achieved at least during the two phase transitions. Advantageously, the first switch segment (polyester) has a mean molecular weight in the range of from 2 000 to 100 000 g/mol, in particular of from 5 000 to 40 000 g/mol, preferably of approximately 10 000 g/mol. Independently thereof, the mean molecular weights of the second switch segment (polyether) in the range of from 100 to 10 000 g/mol, in particular of from 500 to 5 000 g/mol, preferably of approximately 1 000 g/mol, have proved to be successful. Preferably a mass fraction of the polyester segment in the shape memory polymer is in the range of from 25 to 65%, in particular in the range of from 30 to 60%. Correspondingly, the polyether segment is present in a mass fraction in the range of from 35 to 75%, in particular in the range of from 40 to 70%.

The polymer system in accordance with the invention may be a polymer network, wherein the polymer chains comprising the switch segments may exist cross-linked with each other, or may be an interpenetrating network (IPN) or a semi-interpenetrating network (SIPN). Preferably, the system exists as a polymer network, wherein one of the switch segments, in particular the polyester exists cross-linked and the other switch segment, in particular the polyether, is bound in the form of free side chains to the cross-linked switch segment or to a polymer spine structure. In so doing, in accordance with a special embodiment of the invention, the spine structure may be formed by the cross-linking units of both polymer components themselves, in particular, by acrylate and methacrylate groups.

The shape memory polymer in accordance with the invention can be advantageously prepared in that

a polyester macromer having the general Formula Ia where n=1 . . . 6 and Y representing any connecting radical, or a copolyester having the general Formula Ia (where n and Y have the above meaning) having at least two ester units with different n, or a derivative thereof, and

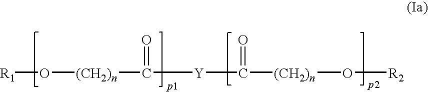

a polyether macromer having the general Formula IIa where m=1 . . . 4, or a copolyether having the general Formula IIa having at least two ether units with different m, or a derivative thereof

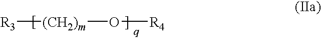

are copolymerized with each other. Preferred embodiments of the polyester and the polyether are selected in accordance with the above description. In so doing, p1 and p2, i.e., the chain lengths of the polyester or the copolyester, in Formula Ia may be the same or different. The radical Y is used exclusively for connecting the two polyester units to each other while reversing the chain direction, so that polymerizable terminal groups may be added to both sides, said groups being used for cross-linking (see below).

A suitable macromer of the polyester component, for example, has the general Formula Ib with r=2 . . . 8 and X=O or NH. Particularly preferred is a component with r=2, p3=2, and X=O, i.e., the polyester macromer is obtained by the polymerization of diethylene glycol HO-CH₂-CH₂-O-CH₂-CH₂-OH with the appropriate ester monomers.

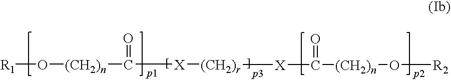

Preferably, the first terminal group R₁ and/or the second terminal group R₂ of the first switch segment represent, independently of each other, a polymerizable radical. Preferably, each of R₁ as well as R₂ represents a polymerizable radical. Particularly preferably used for R₁ and/or R₂ are acryl or methacryl radicals, in particular one methacryl radical, respectively. In this manner, if both components are copolymerized, a network is obtained in which the polyester segments are linked on both sides, whereby, due to the polymerization of the polyester components among each other, poly(meth)acrylate chains are formed, said chains forming a polymer spine that is cross-linked by the polyester chains.

Likewise, the first terminal group R₃ and/or the second terminal group R₄ of the second switch segment may represent, independently of each other, a polymerizable radical. Preferably, only one of the terminal groups R₃ or R₄ is a polymerizable radical, and the other group is a non-reactive radical. This measure results in a linking (grafting) on only one side of the corresponding switch segment, either to the other switch segment or to the optionally existing spine structure. In accordance with a particularly preferred embodiment, the first terminal group R₃ or the second terminal R₄ is an acryl or a methacryl radical, and the other terminal group is an alkoxy radical, wherein, in particular the first terminal group R₃ is a methyl ether radical and the second terminal group R₄ is a methacrylate radical.

Furthermore, the copolymerization may be performed in the presence of at least one additional monomer, in particular in the presence of an acryl or methacryl monomer. Consequently, a poly(meth)acrylate is formed that forms an additional component having the aforementioned spine structure.

Consequently, referring to a particularly preferred embodiment, the first macromer, poly(ε-caprolactone)-dimethacrylate (PCLDMA), having Formula Ic is copolymerized with the second macromer, poly(ethylene glycol) methyl ether methacrylate (PEGMMA) having Formula IIc. As a result of this, a spine structure is created that consists of linearly polymerized methacrylate units of PCLDMA macromers and PEGMMA macromers. This spine is linked by PCL chains (bound on both sides) and has PEG chains in the form of free side chains (bound on one side).

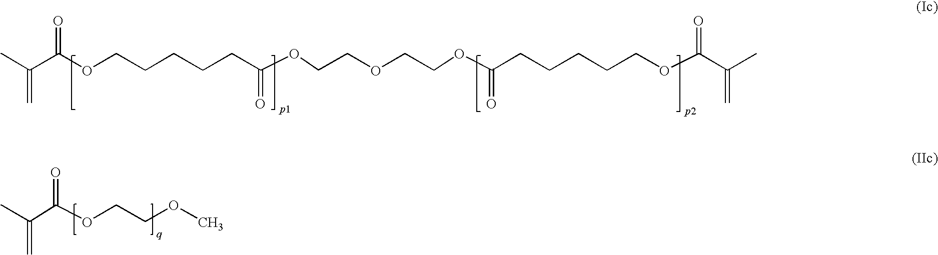

Another important aspect of the invention relates to a method for programming at least two temporary shapes in a shape memory polymer in accordance with the invention. The method in accordance with the invention comprises the following steps:
(a) Transformation of the shape memory polymer into a shape corresponding to the first temporary shape, at a temperature above the upper transition temperature;
(b) cooling to a temperature below the upper transition temperature, while fixing the first temporary shape;
(c) transformation of the shape memory polymer into a shape corresponding to the second temporary shape, at a temperature above the lower transition temperature and below the upper transition temperature; and
(d) cooling to a temperature below the lower transition temperature, while fixing the second temporary shape.

In so doing, the cooling occurring in step (b) may be selectively achieved by cooling to an intermediate temperature below the upper transition temperature and above the lower transition temperature, or to a temperature below the lower transition temperature. For fixing the first temporary shape it is decisive for cooling to occur below the upper transition temperature. If the shape memory polymer is a polymer that can memorize two temporary shapes, i.e., it comprises at least three switch segments, additional temporary shapes are programmed analogously in that, respectively above the appropriate transition temperature, a deforming force is applied, and the temporary shape is fixed by cooling to below this transition temperature while maintaining the deforming force.

The shape memory polymer in accordance with the invention is particularly suitable for medical applications, in particular as implant material. For example, it can be used as an intelligent implant material, whereby thermal stimulation can be used to retrieve the memorized shapes and, as a result of this, an adaptation to existing anatomical situations becomes possible. In so doing, physiologically safe transition temperatures, as well as good bioresorption, are advantageously and effectively attained.

Additional preferred embodiments of the invention result from the remaining features disclosed in the subordinate claims.

Hereinafter, exemplary embodiments are used to explain the invention with reference being made to associate drawings. They show in

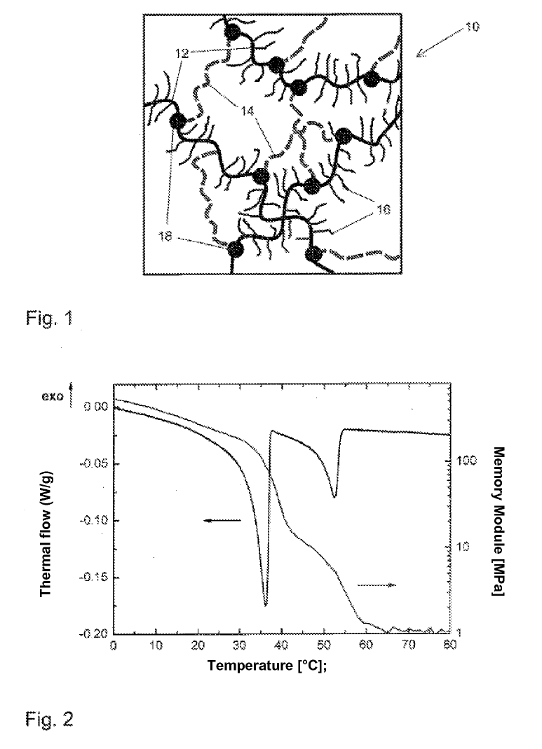

FIG. 1 structure of an inventive graft polymerization network obtained by the copolymerization of PCLDMA and PEGMMA;

FIG. 2 DSC and DMTA examinations of phase transitions of PCL-PEG networks having different compositions;

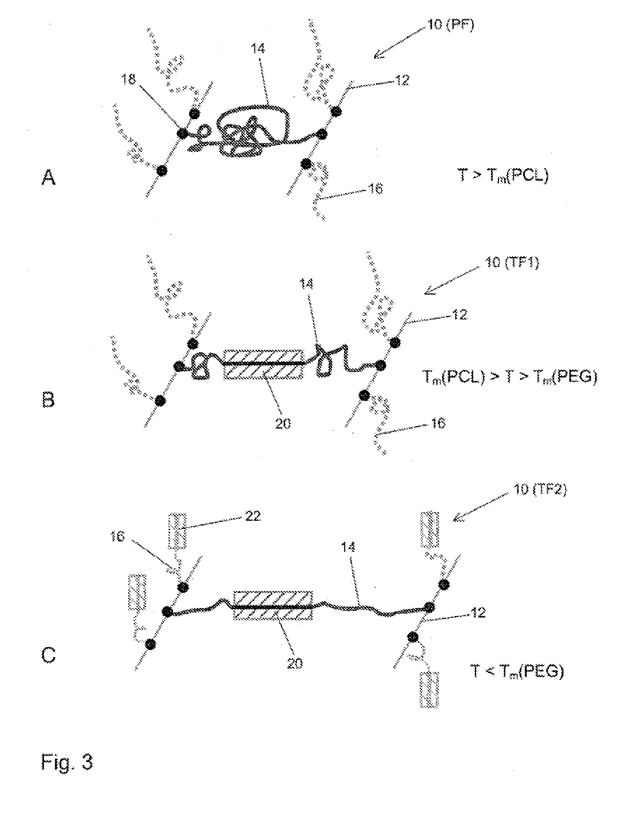

FIG. 3 programming of a graft polymer network in accordance with FIG. 1;

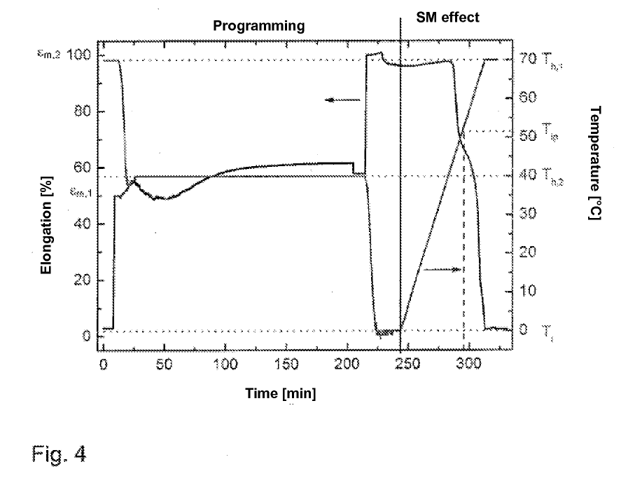

FIG. 4 graphs of various programming parameters over time in a cyclic, thermomechanical experiment; and,

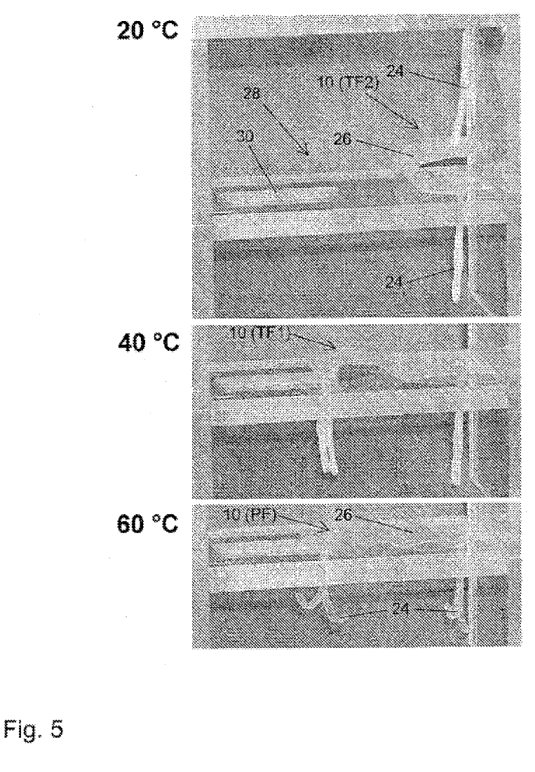

FIG. 5 shape memory polymer in accordance with the invention represented by one exemplary embodiment.

### 1. SYNTHESIS OF POLY(ε-CAPROLACTONE) DIMETHACRYLATE PCL10kDMA

500 g (50 mmol) of poly(c-caprolactone) diol (Aldrich) having a mean molecular weight of 10 000 g/mol (PCL10k diol) are placed in 5 L of dichloromethane in a dry 3-neck flask in a nitrogen atmosphere. While cooling with ice, 20.0 mL (0.14 mol) of triethylamine are added dropwise. After stirring for 10 min at 0° C., 17.4 mL (0.18 mol) of methacryloyl chloride are added dropwise. The solution is heated to room temperature and stirred for another 24 hours. The precipitated salt is removed by filtration. The filtrate is concentrated and dissolved in ethyl acetate. This solution is precipitated in a 10 times excess of a mixture of hexane/diethyl ether/methanol (18:1:1 parts by volume) at −20° C. After vacuum drying, 475 g (47 mmol of poly(ε-caprolactone) dimethacrylate PCLMDA having a mean molecular weight of 10 kD (PCL10 kDMA) having the Formula Ic (see above) are obtained (yield, 95%). The degree of functionalization of the PCL diols having methacrylate terminal groups was determined with ¹H-NMR spectroscopy to be approximately 85%. This means that 72% of the macromers are functionalized on both sides (dimethacrylate), 26% are functionalized on one side (monomethacrylate), and 2% are present as diol and not functionalized.

### 2. COPOLYMERIZATION OF PCLMDA AND PEGMMA

PCL10kDMA prepared in accordance with Example 1 and polyethylene glycol methyl ether methacrylate (PEG1kMMA) (Polyscience) having Formula IIc (see above) and having a mean molecular weight of 1 000 g/mol are weighed in various mixing ratios in accordance with Table 1. (The degree of functionalization with methyl methacrylate (MMA) terminal groups of PEG1kMMA was determined to be 100% with MALDI-TOF mass spectrometry.) The mixtures of PCL10kDMA and PEG1kMMA are melted in a vacuum furnace at 80° C. in order to achieve a good mixture. This prepolymer mixture is poured on a glass plate (10×10 cm) and again placed in the furnace. After a bubble-free homogenous melt is obtained, the mould is closed with another glass plate placed thereon, with the lateral arrangement of PTFE spacers (thickness, 0.55 cm). The structure that is fixed by clamps is irradiated for 80 min with UV radiation (Fe-doped mercury vapor lamp) in order to trigger cross-linking. Pure PCL10kDMA and pure PEG1kMMA as reference materials are treated accordingly in order to obtain a homopolymer network of PCL10kDMA (PCL(100) in Table 1) or linear homopolymers of PEG1kMMA (P[PEGMMA] in Table 1).

TABLE 1

| Polymer# | PCL10kDMA [g] | PEG1kMMA [g] |
|---|---|---|
| P[PEGMMA] | — | 8.50 |
| PCL(20)PEG | 1.50 | 6.00 |
| PCL(30)PEG | 2.25 | 5.25 |
| PCL(40)PEG | 3.00 | 4.50 |
| PCL(50)PE6 | 3.50 | 3.50 |
| PCL(60)PEG | 4.53 | 3.02 |
| PCL(70)PEG | 5.25 | 2.25 |
| PCL(80)PEG | 6.00 | 1.50 |
| PCL(100) | 8.50 | — |

#The numbers in parentheses indicate the mass fraction of PCL10kDMA in the polymer network.

FIG. 1 is a schematic of the structure of a thusly obtained PCL-PEG polymer network that has the reference number 10. It shows the spine 12. The spine 12 is essentially composed of linear polymethacrylate chains of the PCL10kDMA macromers and the PEG1kMMA macromers that are polymerized together. The spine 12 is cross-linked with PCL10kDMA chains 14 having bonds on both sides, whereas the PEG1kMMA 16 is bound to the spine 12 in the form of free side chains. The linkage points 18 represent the linkage sites between the spine 12 and the PCL10 kDMA chains 14.

### 3. CHARACTERIZATION OF THE POLYMER NETWORKS OF PCLDMA AND PEGMMA

The thermal properties of the polymer networks of PCL10kDMA macromers and PEG1kMMA macromers having different compositions and being prepared in accordance with Example 2 are examined by dynamic difference calorimetry (DSC) and by dynamic mechanical thermo analysis (DMTA). The DSC measurements are performed on a Netzsch DSC 204 Phoenix apparatus. To do so, 5 to 10 mg of the samples are placed in an aluminum vessel and the measurements are performed in a nitrogen atmosphere at a cooling and heating rate of 1 K·min⁻¹ within a temperature range of −100 and +100° C. The results are summarized in Table 2. DMTA measurements are performed on an Explexor 5 N (Gabo) which is equipped with a 25N force absorber. The static load is 0.50%, the dynamic load 20%, the frequency 10 Hz, and the heating rate 2 K·min⁻¹ within a temperature range of −100 and +100° C. The results are also summarized in Table 2. FIG. 2 shows the thermal flow dQ/dt (unit, W/g) for the polymer network PCL(50)PEG, as well as the memory module E′ (unit, MPa) determined with DMTA in a temperature range of from 0 to 80° C.

TABLE 2

| | DSC | | | DMTA | | |
|---|---|---|---|---|---|---|
| | T_{g} | Tₘ (PEG) | Tₘ (PCL) | T_{g} | Tₘ (PEG) | Tₘ (PCL) |
| Polymer# | [° C.] | [° C.] | [° C.] | [° C.] | [° C.] | [° C.] |
| P[PEGMMA] | n.b. | 39.3 ± 0.5 | — | n.b. | n.b. | n.b. |
| PCL(20)PEG | n.b. | 38.3 ± 0.5 | 53.3 ± 0.5 | n.b. | n.b. | n.b. |
| PCL(30)PEG | −64.1 ± 1.0 | 37.7 ± 0.5 | 54.5 ± 0.6 | −53 ± 1 | 36 ± 1 | 53 ± 1 |
| PCL(40)PEG | −60.9 ± 1.0 | 37.3 ± 0.5 | 53.2 ± 0.5 | −54 ± 1 | 38 ± 1 | 52 ± 1 |
| PCL(50)PEG | −61.6 ± 1.0 | 35.9 ± 0.5 | 52.7 ± 0.5 | −55 ± 1 | 36 ± 1 | 55 ± 1 |
| PCL(60)PEG | −60.9 ± 1.0 | 32.8 ± 0.5 | 54.5 ± 0.5 | −54 ± 1 | 37 ± 1 | 50 ± 1 |
| PCL(70)PE6 | −61.4 ± 1.0 | 25.5 ± 0.5 | 53.0 ± 0.5 | −56 ± 1 | 7 ± 1 | 51 ± 1 |
| PCL(80)PEG | −63.6 ± 1.0 | 17.4 ± 0.5 | 53.4 ± 0.5 | −58 ± 1 | 3 ± 1 | 52 ± 1 |
| PCL(100) | −60.8 ± 1.0 | — | 55.7 ± 0.5 | −53 ± 1 | — | 54 ± 1 |

#The numbers in parentheses indicate the mass fraction of PCL10kDMA in the polymer network.

It is obvious that the inventive polymer network containing PCL and PEG segments displays two well-differentiated phase transitions within the range of 0 and 80° C. that can be attributed to the melting of PEG and PCL crystallites. In so doing, the lower melting temperature Tₘ is clearly associated with the melting or the crystallization of the PEG segments, said temperature being observed at 39° C. in the case of the homopolymer P[PEGMMA] and between 38 and 32° C. in the copolymer with a PCL mass fraction between 20 and 60%. In contrast, the upper melting temperature Tₘ can be clearly associated with the melting or the crystallization of PCL segments, said temperature being observed at approximately 55° C. in the case of the homopolymer PCL(100) and at 53 to 54° C. in the case of all copolymers. These results show that the graft polymer network in accordance with the invention displays a phase-segregated morphology, whereby the PCL segments and the PEG segments form their own domains with their own transition temperatures that are suitable for temperature-controlled fixing of two temporary shapes.

The observation, based on which the melting temperature of the PEG segments drops significantly starting with a PCL content of 70%, demonstrates that a critical PEG mass fraction of 40% in the polymer network is required in order to obtain a suitable PEG crystal size. As opposed to this, it is possible to conclude, based on the constant melting temperature of the PCL segments, that, with a PCL mass fraction of 20%, the required critical crystal size of the PCL segments has already been achieved.

### 4. PROGRAMMING OF A POLYMER NETWORK OF PCLDMA AND PEGMMA

A graft polymer network PCL(40)PEG prepared in accordance with Example 2 and based on 40 wt. % of PCL10kDMA and 60 wt. % of PEG1kMMA is programmed in a cyclic thermomechanical experiment in such a manner that, in addition to the preparation-specific permanent shape, two temporary shapes are stored in the “shape memory” of the polymer. Basically, this is achieved by fixing a first temporary shape at a temperature below the melting temperature of PCL (Tₘ(PCL)) or at a temperature below the melting temperature of PEG (Tₘ(PEG)), and by subsequently fixing a second temporary shape at a temperature below the melting temperature of PEG (Tₘ(PEG).

This principle is explained with reference to FIG. 3, whereby the same reference symbols as in FIG. 2 are used. In so doing, FIG. 3A shows the structure of the polymer network 10 above the upper transition temperature, i.e., above the melting temperature (Tₘ(PCL) of the PCL segments 14. At this temperature, the PCL segments 14 and also the PEG segments 16 exist in amorphous state as has been illustrated in the drawing by the subordinate segments 14, 16. In this starting phase of the programming process, the polymer 10 is initially still present in its permanent shape PF that is preparation-process-specific, in particular a shape that has been prespecified during cross-linking.

Starting with the shape shown in FIG. 3A, the polymer network 10 is imparted with a shape during the first step, said shape corresponding to a first temporary shape TF1. This is achieved by applying a suitable mechanical load above Tₘ(PCL), said load, for example, resulting in an elongation of the polymer 10. In FIG. 3B this is indicated by an enlarged distance of the spinal chains 12. Following the elongation, the polymer system 10 is cooled to a temperature that, in any event, is below the melting temperature Tₘ(PCL), in particular between Tₘ(PEG) and Tₘ(PCL). Cooling leads to a crystallization of the PCL segments 14, at least in sections. FIG. 3B shows the crystalline PCL segments 20. The first temporary shape TF1 may optionally be stabilized for a prespecified period by tempering at the temperature T<Tₘ(PCL). During this, the mechanical load is continued to be applied.

During the next step, programming of the second temporary shape TF2 occurs analogously to the first temporary shape TF1. In particular, a second mechanical stimulus is used to convert the polymer 10 into the second temporary shape TF2, which, for example, may be achieved by an additional elongation at a temperature above Tₘ(PEG) (FIG. 3C). Subsequently, cooling to a temperature below the lower transition temperature, i.e., the melting temperature of Tₘ(PEG) of the PEG segments, occurs in order to fix the second temporary shape TF2. In so doing, crystalline PEG segments 22 of the PEG side chains 16 are formed. While maintaining the mechanical load, the polymer network 10 may also still be tempered for a certain period of time during this step, thereby also promoting the formation of PCL crystallites.

Starting with a polymer network 10 programmed in this manner, said network being present in its second temporary shape TF2, the first temporary shape TP1 and the permanent shape PF can be retrieved in succession when the polymer 10 is first heated to an intermediate temperature Tₘ(PEG)<T<Tₘ(PCL) and, subsequently, to a temperature above Tₘ(PCL). The restoration of previously fixed shapes is referred to as the shape memory effect (SM effect).

FIG. 4 shows the temperature curves as well as the elongation during a programming cycle and retrieval cycle of the polymer PCL(40)PEG.

The programming cycle starts at a temperature T_{h,1} of 70° C. above Tₘ(PCL) (approximately 53° C.). This is followed by an elongation of the polymer to 50% (ε_{m,1}), consistent with the first temporary shape TF1. Subsequently, while continuing the application of the mechanical load, cooling takes place at a temperature gradient of 4 K·min⁻¹ to an intermediate temperature of 40° C. (T_{h,2}) below Tₘ(PCL) and above Tₘ(PEG) (approximately 37° C.). After a holding time of three hours the polymer is relaxed, indicating a slight reversal of the elongation. Subsequently, the sample is held another 10 min without the application of a mechanical load in order to then elongate the sample to the 100% of total elongation (ε_{m,2}), cool it under constant mechanical load to 0° C. (T₁), and maintain the mechanical load for another 10 min, whereby the elongation decreases slightly.

Upon completion of the programming cycle, the memorized shapes are retrieved in succession in that (without application of a mechanical load) a heating rate of 1 K·min⁻¹ is used to re-heat the sample from 0 to 70° C. In so doing, first the melting of the PEG crystallites and the restoration of the second temporary shape at Tₘ(PEG) are observed. If the temperature is held for one hour at 40° C., the second temporary shape remains stable and there is no transformation into the permanent shape (not illustrated). Continued heating above Tₘ(PCL) causes the PCL crystallites to melt and to achieve an almost quantitative restoration of the permanent shape. This programming and restoring cycle was performed four more times with the same result.

FIG. 5 shows an example to demonstrate the practical application of a programmed inventive polymer network in accordance with Example 2. In so doing, the top part of the Figure shows the second temporary shape TF2 of the polymer 10 at a temperature of 20° C. The polymer 10 has two elongated side sections 24 that are attached to a planar central section 26. The polymer 10 is mounted to a transparent plastic carrier 28 that has an opening 30. While heating the polymer system 10 to a temperature of 40° C., a deformation of the central section 26 from the bent shape depicted in the top part into a flat shape (FIG. 5, central part) that corresponds to the first temporary shape TF1 takes place. In so doing, the side sections 24 remain mostly unchanged. During the restoration of the first temporary shape TF1, the left side section 24 extends through the opening 30 of the plastic carrier 28. With continued heating of the polymer system 10 to 60° C., the side sections 24 are caused to bend upward and now assume a hook-like shape (FIG. 5, bottom part). At the same time, the central section 26 remains virtually unchanged. The shape shown in the bottom part of FIG. 5 corresponds to the permanent shape PF of the polymer network 10.

### LIST OF REFERENCE SIGNS

PF permanent shape
TF1 first temporary shape
TF2 second temporary shape
T_{trans,1} first transition temperature
T_{trans,2} second transition temperature
Tₘ(PCL) melting temperature of the PCL segments
Tₘ(PEG) melting temperature of the PEG segments
10 polymer network
12 spine
14 cross-linking polymer (PCL10kDMA)
16 side chain polymer (PEG1kMMA)
18 linkage points
20 crystalline PCL segment
22 crystalline PEG segment
24 side section
26 central section
28 plastic carrier
30 opening

1. A shape memory polymer comprising at least two switch segments having different transition temperatures so that the polymer may assume, as a function of temperature, at least two temporary shapes in addition to the permanent shape, characterized in that a first switch segment is essentially based on a polyester having Formula I where n=1 . . . 6, or on a copolyester having general Formula I with different n, or on a derivative thereof, and a second switch segment is essentially based on a polyether having general Formula II where m=1 . . . 4, or on a copolyether having general Formula II with different m, or on a derivative thereof 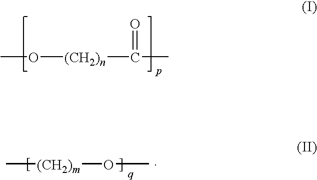
characterized in that
one of the first switch segments exists cross-linked and the other switch segment in the form of free side chain bound to the cross-linked switch segment or to a polymer spine structure.

2. Shape memory polymer in accordance with claim 1, characterized in that the first switch segment comprises a poly(ε-caprolactone) segment where n=5, or a derivative thereof, wherein the aliphatic carbon atoms, independently of each other, may be substituted with one or two, unbranched or branched, saturated or unsaturated C1 through C6 radicals.

3. Shape memory polymer in accordance with claim 1, characterized in that the second switch segment comprises a polyethylene glycol segment where m=2, or a derivative thereof, wherein the aliphatic carbon atoms, independently of each other, may be substituted with one or two, unbranched or branched, saturated or unsaturated C2 through C6 radicals.

4. Shape memory polymer in accordance with claim 1, characterized in that the first switch segment has a mean molecular weight in the range of from 2 000 to 100 000 g/mol.

5. Shape memory polymer in accordance with claim 1, characterized in that the second switch segment has a mean molecular weight in the range of from 100 to 10 000 g.

6. Shape memory polymer in accordance with claim 1, characterized in that one mass fraction of the polyester segment in the shape memory polymer is in the range of from 25 to 65%.

7. Shape memory polymer in accordance with claim 1, characterized in that the polymeric spine structure is formed by polyacrylate chains polymethacrylate chains.

8. Shape memory polymer in accordance with claim 1, characterized in that the polyester exists cross-linked and the polyether is bound in the form of free side chains to the cross-linked switch segment or to the polymer spine structure.

9. A method for the preparation of a shape memory polymer, whereby a polyester having general Formula Ia where n=1 . . . 6 and Y representing a binding radical, or a copolyester having general Formula Ia with different n, or a derivative thereof, and a polyether having general Formula IIa where m=1 . . . 4, or a copolyether having general Formula II with different m, or a derivative thereof, are copolymerized

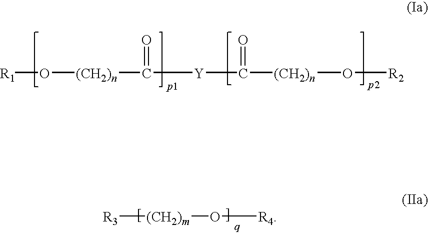

10. Method in accordance with claim 9, characterized in that the first terminal group R1 or the second terminal group R2 of the first switch segment represent, independently of each other, a polymerizable radical, whereby in particular each of R1 and R2 is a polymerizable radical.

11. Method in accordance with claim 10, characterized in that the first terminal group R1 or the second terminal group R2 of the first switch segment represent an acryl or methacryl radical, respectively.

12. Method in accordance with claim 9, characterized in that the first terminal group R3 or the second terminal group R4 of the second switch segment represent, independently of each other, a polymerizable radical, and that in particular only one of the terminal groups R3 or R4 is a polymerizable radical and the other is a non-reactive radical.

13. Method in accordance with claim 12, characterized in that the first terminal group R3 or the second terminal group R4 is an acryl or methacryl radical, and the other terminal group is an alkoxy radical, whereby in particular the first terminal group R3 is a methyl ether radical and the second terminal group R4 is a methacrylate radical.

14. A method for programming at least two temporary shapes in a shape memory polymer, comprising the steps hereinafter, characterized by
(a) transforming the shape memory polymer into a shape corresponding to the first temporary shape, at a temperature above the upper transition temperature;
(b) cooling to a temperature below the upper transition temperature, while fixing the first temporary shape;
(c) transforming of the shape memory polymer into a shape corresponding to the second temporary shape, at a temperature above the lower transition temperature and below the upper transition temperature; and
(d) cooling to a temperature below the lower transition temperature; while fixing the second temporary shape.

15. Method in accordance with claim 14, characterized in that, in step (b), cooling occurs to a temperature below the upper transition temperature and above the lower transition temperature, or to a temperature below the lower transition temperature.

16. A method comprising using a shape memory polymer as a medical material,
wherein the polymer comprises at least two switch segments having different transition temperatures so that the polymer may assume as a function of temperature at least two temporary shapes in addition to the permanent shape characterized in that a first switch segment is essentially based on a polyester having Formula I where n=1 . . . 6 or on a copolyester having general Formula I with different n, or on a derivative thereof, and a second switch segment is essentially based on a polyether having general Formula II where m=1 . . . 4 or on a copolyether having general Formula II with different m, or on a derivative thereof 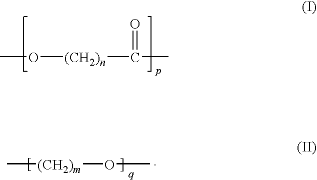
characterized in that
one of the first switch segments exists cross-linked and the other switch segment in the form of free side chain bound to the cross-linked switch segment or to a polymer spine structure.

17. The method of claim 16, wherein the medical material includes an implant material
